(19) United States
(12) Patent Application Publication
(10) Pub. No.: US 2015/0053290 A1
(43) Pub. Date: Feb. 26, 2015

(54) Medical Gas Manifold

(71) Applicant: Pentair Flow Services AG, Schaffhausen (CH)

(72) Inventors: Mark K. Hamm, Cullman, AL (US); William C. Osteen, Hartselle, AL (US); John B. Miller, Arab, AL (US)

(21) Appl. No.: 14/469,327

(22) Filed: Aug. 26, 2014

Related U.S. Application Data
(60) Provisional application No. 61/870,147, filed on Aug. 26, 2013.

(51) Int. Cl. F16K 27/00

(52) U.S. Cl. CPC F16K 27/003
USPC 137/884

(57) ABSTRACT

A medical gas manifold including a bank body formed as a single body and including a primary bank regulator valve body and a secondary bank regulator valve body, a primary bank regulator received within the primary bank regulator valve body, a secondary bank regulator received in the secondary bank regulator valve body, a line body formed as a single body and including a first line regulator valve body and a second line regulator valve body, a first line regulator received in the first line regulator valve body, a second line regulator received in the second line regulator valve body, a primary ball valve fluidly coupling the first line regulator to the bank body, and a secondary ball valve fluidly coupling the second line regulator to the bank body.

### RELATED APPLICATIONS

This application claims priority to U.S. Provisional Application No. 61/870,147 filed on Aug. 26, 2013, the entire disclosure of which is hereby incorporated herein by reference.

### BACKGROUND

The invention relates generally to manifolds for handling medical gases, for example in a hospital setting.

Typically, oxygen, nitrogen, nitrous oxide, carbon dioxide, compressed air, or other gases may be supplied in a hospital setting for patient care, medical aids, or mechanical operation of equipment. Additionally, mixtures of these gases and other gases, as well as vacuum capabilities, are typically part of the hospital environment.

In typical medical or hospital applications, oxygen is delivered for end use at pressures of around 55 pounds per square inch (psi), nitrous oxide at about 50 psi, nitrogen at about 175 psi, carbon dioxide at about 50 psi, medical air at about 55 psi, and instrument air at about 175 psi.

Gases, such as those listed above, are typically stored in banks of either high-pressure cylinders (e.g., at pressures up to about 2500 psi) or cryogenic tanks (e.g., for oxygen and nitrogen) and then delivered at the lower end use pressures using appropriate regulators and associated hardware.

Regulators used in hospital settings must have built in redundancy and meet stringent requirements that are not typical elsewhere. Relevant best practices are well understood and have become codified in various regulations. These include (but are not limited to) the NFPA regulations in United States (e.g. 38 CFR 51.200), the CSA regulations in Canada, and the ISO regulations in Europe.

One requirement that gas delivery systems must meet for use in hospitals is to provide a non-interrupted gas supply under normal circumstances (e.g., repair or resupply) or even in many abnormal circumstances. To address the need for redundancy, hospitals typically utilize a primary source of gases (i.e., the primary side) and a complementary back up set of gases (i.e., the secondary side). In order to provide consistent gas delivery without interruptions, the gas delivery system often includes a regulator manifold that integrates the primary side and the secondary side and provides a consistent flow of gas to a point of use.

Conventionally, the required equipment and redundancy is built from existing (“off-the-shelf”) components. Although such readily available parts can superficially lower initial costs, such conventional equipment (e.g., regulators, valves, fittings) can suffer from certain disadvantages. For example, the way current systems are put together leads to a large number of leak points. Currently, thread tape or paint is relied on heavily which leads to inconsistent installation necessitating a significant amount of leak checking. Additionally, thread tape can lead to foreign objects (e.g., pieces of tape) getting lodged in regulators and/or other components resulting in system failure.

One disadvantage is the incompatibility of many materials typically present in off-the-shelf regulators and other components. Certain polymer rubbers (elastomers) have properties that make them incompatible with certain hospital gases. Generally, some elastomers are compatible with oxygen, but not nitrous oxide or carbon dioxide (and vice versa). As an example, some halogenated elastomers give off toxic fumes when ignited.

The problems with material incompatibility are exaggerated in situations involving rapid pressure change (increase or decrease). In some situations, the pressure of the gas may be regulated from about 2500 psi in a bank to 250 psi in a manifold; this can produce two potential failure modes. In the first, a rapid increase in pressure leads to adiabatic compression that can significantly elevate the gas temperature and potentially lead to ignition. When oxygen is passing through the gas delivery system and undergoes adiabatic compression in the presence of hydrocarbon-based elastomers (e.g., sealing o-rings and related parts), combustion can, and does, result. In the second mode, gas can permeate an o-ring at high pressure, and upon rapid decompression can release the permeated gas causing fissures, and other damage to the structure of the o-ring or seal. Such events can and do affect the useful life and effectiveness of the seals. Some examples of hydrocarbon rubbers which may be unsuitable in various situations but are typically used include polyurethane, styrene butadiene, polyisoprene and ethylene-propylene-diene.

To deal with material incompatibility, gas delivery systems are designed and materials are selected to avoid potential problems, often at the cost of efficiency and cost. In other words, current gas delivery systems need to be custom built and designed for the gas and situation desired.

Another disadvantage of current gas delivery systems is that the piece-meal construction does not sufficiently inhibit users (e.g., maintenance workers) from removing items from the gas delivery system thereby affecting the structural integrity of the system.

Another disadvantage is that conventional regulators can permit larger than desired drops in pressure during flow. Elastomer diaphragms used in conventional regulators tend to exhibit droop. Droop occurs when the inlet pressure source (i.e., pressure provided by the bank) is reduced, and subsequently regulator delivery pressure may either rise or fall depending upon the regulator design. The side loading design of many regulator piston assemblies tends to increase both the friction within the regulator and the level of droop experienced by the assembly. Additionally, balancing the piston assembly on the line regulator also tends to increase friction and droop.

Another disadvantage of current gas delivery systems is the large amount of labor required to remove components of the system for service or replacement. Typical systems are wall mounted and made of a large number of individual parts connected by pipe, threaded fittings, and various control components. Servicing such systems is inefficient, time consuming, and costly. Additionally, such systems are non-uniform and result in inconsistent servicing leading to variable quality of installation and servicing.

### BRIEF SUMMARY OF THE INVENTION

Therefore, an improved gas delivery system is desirable. In particular, a gas manifold that incorporates a primary side regulator, a secondary side regulator, and line pressure regulators and addresses at least the above disadvantages is desirable.

In one aspect, the present invention provides a medical gas manifold including a bank body formed as a single body and including a primary bank regulator valve body and a secondary bank regulator valve body, a primary bank regulator received within the primary bank regulator valve body, a secondary bank regulator received in the secondary bank regulator valve body, a line body formed as a single body and including a first line regulator valve body and a second line regulator valve body, a first line regulator received in the first line regulator valve body, a second line regulator received in the second line regulator valve body, a primary ball valve fluidly coupling the first line regulator to the bank body, and a secondary ball valve fluidly coupling the second line regulator to the bank body.

In another aspect, the present invention provides a medical gas manifold that includes a bank body arranged to receive a primary bank regulator and a secondary bank regulator. The bank body is forged as a single piece and subsequently machined to include a bank check valve portion, a bank coupling portion, and a bank branch. A line body is arranged to receive a first line regulator and a second line regulator, and is forged as a single piece identical to the bank body and subsequently machined to include a line check valve portion, a line coupling portion, and a line branch. A ball valve fluidly connecting the bank coupling portion to the line body to provide a flow path from the bank body to the line body.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a front pictorial view of a medical gas manifold according to one embodiment of the invention.

FIG. 2 is a section view of the medical gas manifold of FIG. 1 taken along line 2-2 of FIG. 1.

FIG. 3 is a section view of the medical gas manifold of FIG. 1 taken along line 3-3 of FIG. 1.

FIG. 4 is a section view similar to FIG. 3 but including a flexible diaphragm.

FIG. 5 is a detail view of a line regulator of the medical gas manifold of FIG. 1 taken within the line 5-5 of FIG. 2.

FIG. 6 is a back pictorial view of the medical gas manifold of FIG. 1.

FIG. 7 is a section view of a portion of the line regulator of FIG. 5 in a first position.

FIG. 8 is a section view of a portion of a bank regulator of the medical gas manifold of FIG. 1 in a first position.

FIG. 9 is a pictorial view of a bank regulator of the medical gas manifold of FIG. 1 including a relief piston.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

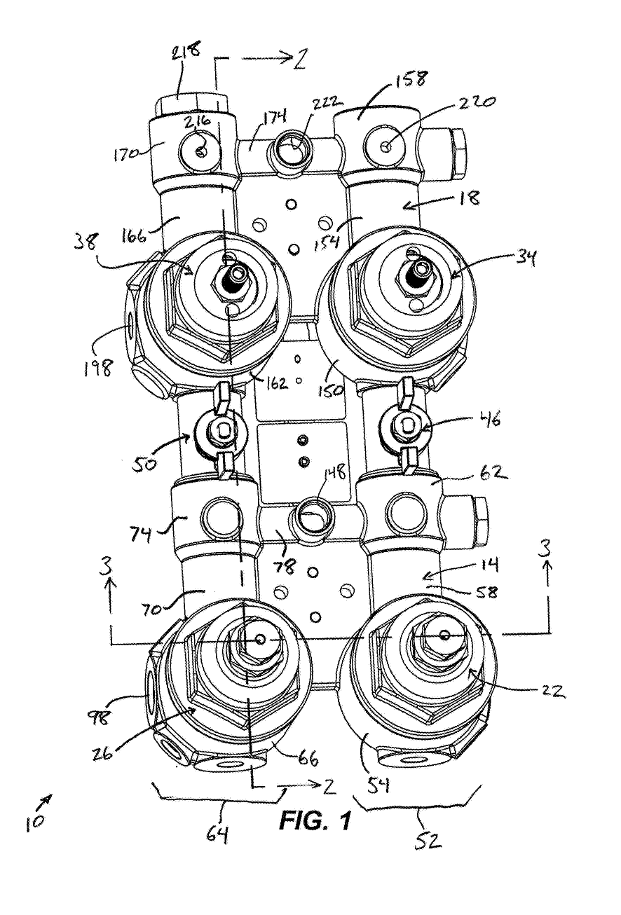

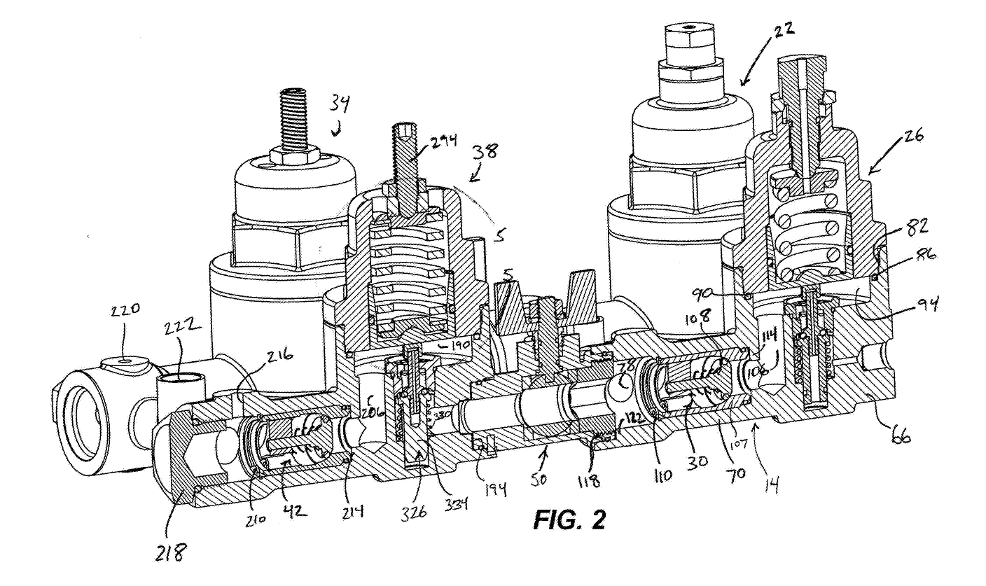

FIG. 1 shows a medical gas manifold 10 that includes a bank side body 14 and a line side body 18. The bank side body 14 and the line side body 18 are each formed as single piece forgings. The bank side body 14 receives a primary bank regulator 22, a secondary bank regulator 26, and two bank check valves 30 (one shown in FIG. 2). The line side body 18 receives a first line regulator 34, a second line regulator 38, and two line check valves 42 (one shown in FIG. 2). The bank side body 14 and the line side body 18 are coupled together by a primary ball valve 46 and a secondary ball valve 50. Detailed descriptions of the components of the medical gas manifold 10 will be discussed below.

The bank side body 14 defines a primary side 52 that includes: a primary valve body 54 in communication with a primary check valve portion 58, and a primary side coupling portion 62; and a secondary side 64 that includes: a secondary valve body 66 in communication with a secondary check valve portion 70, and a secondary side coupling portion 74; and a bank side branch 78 fluidly coupling the primary side coupling portion 62 and the secondary side coupling portion 74. As noted above, the bank side body 14 is formed as a single casting or forging. The various precision features discussed below are final machined into the casting or forging.

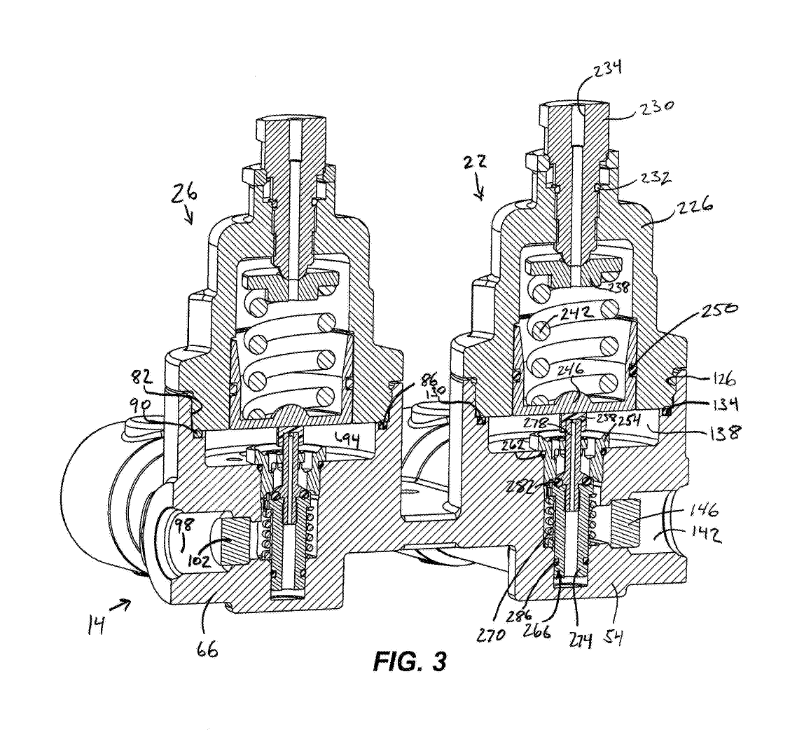

Turning to FIG. 3, the bank side body 14 is shown in cross section through the primary valve body 54 and the secondary valve body 66. The secondary valve body 66 defines a threaded portion 82 arranged to receive the secondary bank regulator 26, an o-ring groove 86 sized to receive a seal in the form of an o-ring 90, and a regulator cavity 94 sized to receive the internal components of the secondary bank regulator 26. The secondary valve body 66 further defines a secondary inlet 98 (see FIG. 1 and FIG. 3) sized to receive a filter element 102 and arranged to provide communication between the secondary bank (not shown) and the secondary bank regulator 26. The secondary valve body 66 further includes a number of sensor ports arranged to provide fluid communication with sensors at various places within the secondary valve body 66.

The illustrated filter element 102 is a sintered bronze and reduces the velocity of fluid (e.g., gas) entering the secondary valve body 66 and thereby contributes to a reduces the relevant fluid temperature during operation of the medical gas manifold 10. For example, a 40 or 45 micrometer sintered brass filter 102 may be configured to substantially fill the secondary inlet 98 and may thereby reduce the speed at which gas enters the secondary valve body 66. In certain configurations, such a filter element 102 (e.g., a 40 micrometer sintered brass filter) may cause a substantial reduction of fluid velocity, may act as a flame arrestor, may improve heat rejection and/or may exhibit favorable particle retention.

The secondary check valve portion 70 is in fluid communication with the regulator cavity 94 via a passage 106 (see FIG. 2) and is sized to receive one of the bank check valves 30. A clip 110 positioned in a clip slot is arranged to hold the bank check valve 30 in place against a shoulder 114.

The bank check valves 30 includes a check valve body 107 sealed to the secondary check valve portion 70 with an o-ring, and a directionally biased valve element 108 that is arranged to selectively allow one-directional flow. Check valves are understood in the art and the particular arrangement of the internal components of the check valve 30 is not limiting to the invention. The placement and position of the check valve 30 within the secondary check valve portion 70 is significant to the invention and provides advantages that will be discussed below and relating to serviceability of the manifold 10 and providing the desired function while in use.

The secondary side coupling portion 74 is arranged to receive the secondary ball valve 50 and defines a sealing surface 118 and a shoulder 122.

The secondary ball valve 50 and the primary ball valve 46 are substantially identical and arranged to selectively allow and inhibit flow therethrough via a quarter turn action. The ball valves 46, 50 are configured to seal via o-rings and without the use of sealing tape or paint. The secondary ball valve 50 engages the sealing surface 118 and abut the shoulder 122 to provide a seal therebetween.

The primary side 52 of the bank side body 14 is significantly the same as the secondary side 64. The primary valve body 54 (see FIG. 3) defines a threaded portion 126 arranged to receive the primary bank regulator 22, an o-ring groove 130 sized to receive a seal in the form of an o-ring 134, and a regulator cavity 138 sized to receive the internal components of the primary bank regulator 22. The primary valve body 54 further defines a primary inlet 142 sized to receive a filter element 146 (substantially the same as filter element 102) and arranged to provide communication between the primary bank (not shown) and the primary bank regulator 22. The primary valve body 54 further includes a number of sensor ports arranged to provide fluid communication with sensors at various places within the primary valve body 54.

The primary check valve portion 58 is in fluid communication with the regulator cavity 138 via a passage 144 (See FIG. 8) and is sized to receive one of the bank check valves 30. A clip (not shown) positioned in a clip slot is arranged to hold the bank check valve 30 in place against a shoulder (not shown).

The primary side coupling portion 62 is arranged to receive the primary ball valve 46 and defines a sealing surface (not shown) and a shoulder (not shown).

The bank side branch 78 is arranged to provide fluid communication between the primary side coupling portion 62 and the secondary side coupling portion 74 downstream of the two bank check valves 30. A bank port 148 is formed in the bank side branch 78 and may be connected, for example, to a relief valve.

With reference to FIGS. 1 and 2, the line side body 18 includes a branch arranged on the primary side 52 that includes: a first line valve body 150 in communication with a first line check valve portion 154, and a first line coupling portion 158; and a branch arranged on the secondary side 64 that includes: a second line valve body 162 in communication with a second line check valve portion 166, and a second line coupling portion 170; and a line side branch 174 fluidly coupling the first line coupling portion 158 and the second line coupling portion 170.

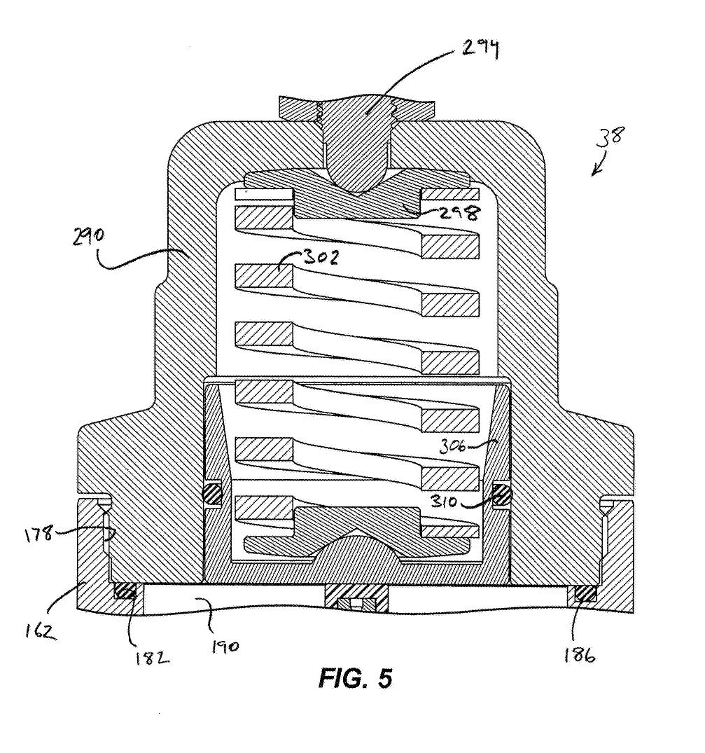

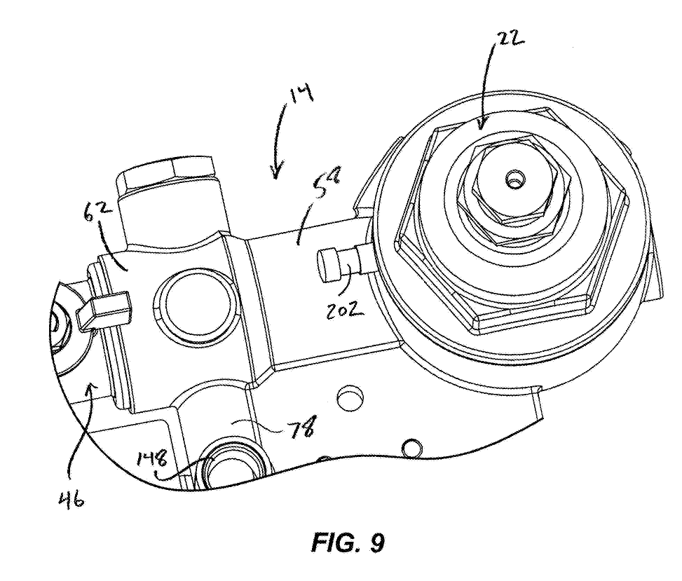

Turning to FIG. 2, the secondary side 64 is shown in cross section. The second line valve body 162 defines a threaded portion 178 (see FIG. 5) arranged to receive the second line regulator 38, an o-ring groove 182 sized to receive a seal in the form of an o-ring 186, and a regulator cavity 190 sized to receive the internal components of the second line regulator 38. The second line valve body 162 further defines a second line inlet 194 (see FIG. 2) sized to receive the secondary ball valve 50 and arranged to provide fluid flow to the second line regulator 38. The second line valve body 162 further includes a relief piston aperture 198 (see FIG. 1) arranged to receive a relief piston 202 (see FIG. 9) for relieving the pressure within the second line regulator 38.

The second line check valve portion 166 is in fluid communication with the regulator cavity 190 via a passage 206 (see FIG. 2) and is sized to receive one of the line check valves 42. A clip 210 positioned in a clip slot is arranged to hold the line check valve 42 in place against a shoulder 214.

The second line coupling portion 170 is arranged in the illustrated example to receive a plug 218. In other embodiments, the second line coupling portion 170 may couple to an outlet, another manifold, or may be used in another arrangement, as desired. Additionally, the second line coupling portion 170 defines a port 216 that may be connected, for example, to a vent valve.

The primary side 52 of the line side body 18 is significantly the same as the secondary side 64. The first line valve body 150 defines a threaded portion (not shown) arranged to receive the first line regulator 34, an o-ring groove (not shown) sized to receive a seal in the form of an o-ring (not shown), and a regulator cavity (not shown) sized to receive the internal components of the first line regulator 34. The first line valve body 150 further defines a first line inlet (not shown) sized to receive the primary ball valve 46 and arranged to provide fluid flow to the first line regulator 34. The first line valve body 150 further includes a relief piston aperture (not shown) arranged to receive a relief piston for relieving pressure within the first line regulator 34.

The first line check valve portion 154 is in fluid communication with the regulator cavity of the first line valve body 150 via a passage (not shown) and is sized to receive one of the line check valves 42. A clip (not shown) positioned in a clip slot is arranged to hold the line check valve 42 in place against a shoulder (not shown).

The first line coupling portion 158 is arranged in the illustrated example to couple to an outlet for providing regulated pressure gas. In other embodiments, the first line coupling portion 158 may be in communication with a manifold or another structure, as desired. Additionally, the first line coupling portion 158 defines a port 220 that may be connected, for example, to a vent valve.

The line side branch 174 is arranged to provide fluid communication between the first line coupling portion 158 and the second line coupling portion 170 downstream of the two line check valves 42. The line side branch 174 provides a regulated pressure at the outlet regardless of which line regulator 34, 38 is active. A line port 222 is formed in the line side branch 174 and may be connected, for example, to a relief valve.

The bank side body 14 and the line side body 18 may be formed with a single forging mold. The bank side body 14 is the made different from the line side body 18 by machining the passageways, inlets, outlets, and ports differently. That is to say, the bank side body 14 and the line side body 18 may be identical before final machining. This provides an efficient and cost effective manufacturing process.

Turning to FIG. 3, the primary bank regulator 22 includes a bonnet 226 threadingly engaging the primary valve body 54 and compressing the o-ring 134 to seal the bonnet 226 thereto. A pneumatic adjustment screw 230 is threadingly engaged with a top portion of the bonnet 226 and sealed to the bonnet by an o-ring 232. The pneumatic adjustment screw defines a pneumatic passageway 234. When in use, the pneumatic passageway may receive pressurized fluid to affect the set point of the primary bank regulator 22. For example, the primary bank regulator 22 may be dome loaded by applying the pressure from the outlet 106 to the pneumatic passageway 234. The pneumatic adjustment screw 230 allows for any combination of spring and dome loading, as desired.

The pneumatic adjustment screw 230 engages a spring button 238 and is arranged to adjust the set pressure applied by a set spring 242. The set spring 242 biases a piston diaphragm 246 downward (as viewed in FIG. 3). In the illustrated embodiment, the set spring 242 is formed of phosphor bronze or stainless steel, which may provide an elevated threshold pressure for promoted combustion rating. The piston diaphragm 246 is sealed to the bonnet 226 by an o-ring 250. The piston diaphragm 246 may be formed of a nickel-copper alloy or brass. A brass piston style diaphragm (e.g., piston diaphragm 246) may exhibit a higher auto-ignition resistance than diaphragms of certain other materials.

With reference to FIG. 8, a seat ring 254 is coupled to the primary valve body 54 and arranged beneath the piston diagram 246 with a pusher post button 258 in between. The illustrated seat ring 254 is formed of a nickel-copper alloy such as Monel® or brass. (Monel is a registered trademark of Special Metals Corporation in the United States, foreign jurisdictions, or both.) The seat ring 254 is sealed to the primary valve body 54 by an o-ring 262.

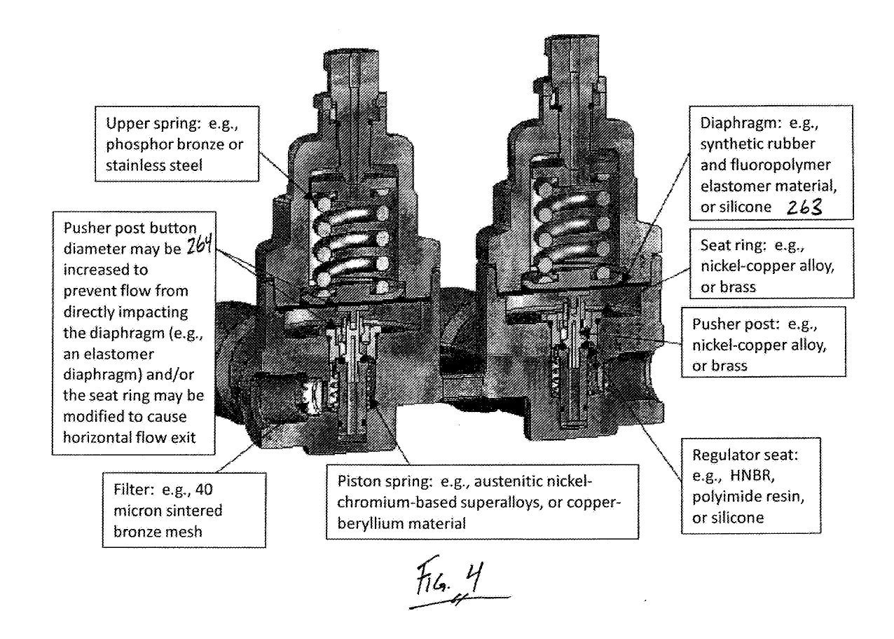

In an alternative arrangement, such as that shown in FIG. 4, the piston diaphragm 246 may be replaced with an elastomeric diaphragm 263 and a larger diameter pusher post button 264 may be used to inhibit flow from directly impacting the diaphragm 264 and/or the seat ring 254 may be modified to cause horizontal flow exit. The illustrated elastomeric diaphragm 263 may be formed from synthetic rubber and fluoropolymer elastomer material, or silicone, for example, the diaphragm 263 may be composed of Viton® material.

A piston assembly 266 is positioned within the regulator cavity 138 and is biased upward (as viewed in FIG. 3) by a seat spring 270. The piston assembly 266 includes a piston base 274, a piston stem 278, o-ring 282 between the base 274 and the stem 278. The base 274 is also sealed to the regulator cavity 138 by an regulator seat 286. The piston base 274 and the piston step 278 may be formed of nickel-copper alloy or brass. The seat spring 270 may be formed of austenitic nickel-chromium-based superalloys, or copper-beryllium material, such as Inconel®. (Inconel is a registered trademark of Special Metals Corporation in the United States, foreign jurisdictions, or both.) Use of such material (or similar material) for a seat spring may, for example, cause a spring to exhibit a higher threshold pressure for promoted combustion rating than springs formed from other materials.

The regulator seat 286 may be composed of a synthetic rubber-derived polymer. For example, the regulator seat 286 may utilize a synthetic rubber-derived polymer such as hydrogenated nitrile butadiene rubber (“HNBR”). This may, for example, facilitate the use of the manifold 10 with a variety of fluid types. In certain embodiments, the regulator seat 286 may additionally or alternatively utilize silicone, or polyimide resin materials, such as Vespel® SP21. (Vespel is a registered trademark of E. I. du Pont de Nemours and Company or its affiliates in the United States, foreign jurisdictions, or both.) In certain embodiments, the regulator seat 286 may additionally or alternatively be composed of a synthetic rubber and fluoropolymer elastomer material (e.g., Viton®). (Viton is a registered trademark of DuPont Performance Elastomers, LLC in the United States, foreign jurisdictions, or both.) In certain embodiments, the regulator seat 286 may additionally or alternatively be composed of ethylene propylene diene monomer (M-class) (“EPDM”) rubber.

The piston assembly 266 is a balanced piston arrangement that allows the primary bank regulator 22 to operate smoothly even with the very large pressure difference acting thereacross. Operation of the primary bank regulator 22 will be readily apparent to those skilled in the art.

In addition to the regulator seat 286, the other o-rings in the system may advantageously be composed of HNBR or the other ideal materials discussed above. The use of specific materials for the seals throughout the manifold 10 facilitates the use of the manifold 10 with a variety of fluid types without the need to change o-rings and seals.

The secondary bank regulator 26 is arranged significantly identically to the primary bank regulator 22 and will not be discussed in detail herein but has been numbered in the drawings with like numbers.

With reference to FIG. 5, the second line regulator 38 includes a bonnet 290 threadingly engaging the second line valve body 162 and compressing the o-ring 186 to seal the bonnet 290 thereto. An adjustment screw 294 is threadingly engaged with a top portion of the bonnet 290. The adjustment screw 294 engages a spring button 298 and is arranged to adjust the set pressure applied by a set spring 302. The set spring 302 biases a piston diaphragm 306 downward (as viewed in FIG. 5). The piston diaphragm 306 is sealed to the bonnet 290 by an o-ring 310.

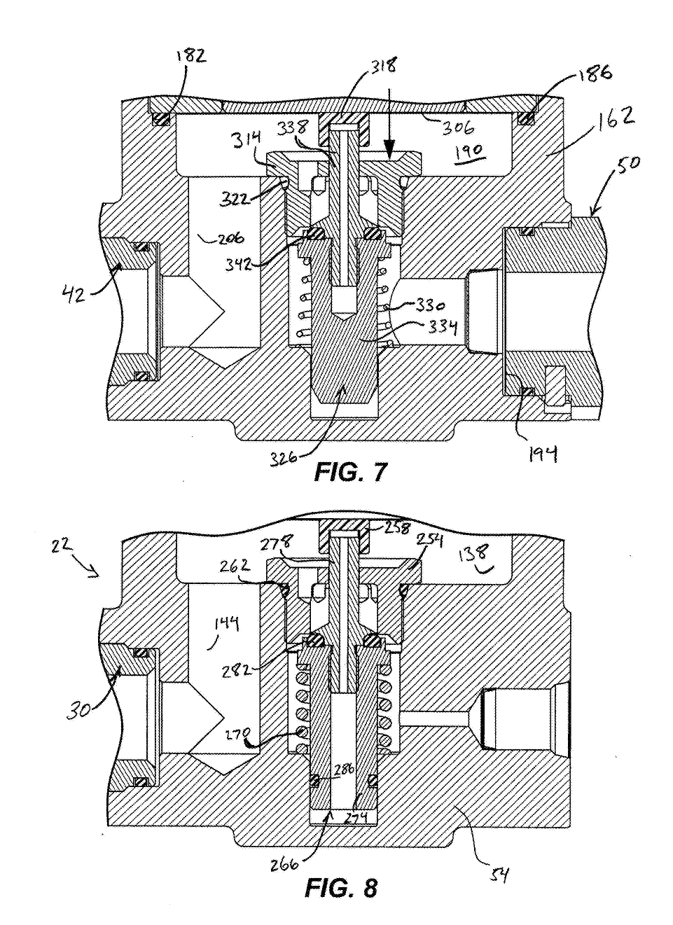

With reference to FIG. 7, a seat ring 314 is coupled to the second line valve body 162 and arranged beneath the piston diagram 306 with a pusher post button 318 in between. The seat ring 314 is sealed to the second line valve body 162 by an o-ring 322. A piston assembly 326 is positioned within the regulator cavity 190 and is biased upward (as viewed in FIG. 7) by a seat spring 330.

The piston assembly 326 includes a piston base 334, a piston stem 338, a regulator seat 342 between the base 334 and the stem 338. The base 334 is not sealed to the regulator cavity 190 by an o-ring such that the piston assembly 326 is not balanced. This arrangement provides faster response. Use of an unbalanced regulator piston assembly 326 may, for example, reduce drag on the relevant regulator pistons and thereby facilitate quicker opening of the pistons in order to meet target flow requirements. For example, drag may be reduced in an unbalanced regulator due to the lack of an o-ring seal near the bottom of a regulator piston. In certain embodiments, a lighter rate piston spring than is typical may also be utilized. This may, for example, also reduce piston load. As such, in certain embodiments, a line regulator (e.g., a second stage pressure reduction) or other regulator in the manifold may include an unbalanced piston configuration as well as a lighter rate piston spring.

As discussed above, the illustrated bank regulators 22, 26 are balanced and the line regulators 34, 38 are unbalanced. In other embodiments, it may be desirable for the bank regulators 22, 26 to be unbalanced, and/or the line regulators to be balanced. In other words, any of the regulators 22, 26, 34, 38 may be either balanced or unbalanced, as desired. In situations where a balanced line regulator is desirable, low friction seals can be used to reduce friction and increase responsiveness. For example, quad ring seals may be used.

The first line regulator 34 is arranged significantly identically to the second line bank regulator 38 and will not be discussed in detail herein. The materials discussed above with respect to the primary bank regulator 22 are applicable to the components of the line regulators 34, 38. For example, in one embodiment, the seats and o-rings are composed of HNBR.

The arrangement of the regulators 22, 26, 34, 38 allows for front-loading servicing. That is to say, the bonnet of a regulator may be unthreaded from the corresponding body and the internal components of that regulator may be serviced without disassembling the entire manifold 10.

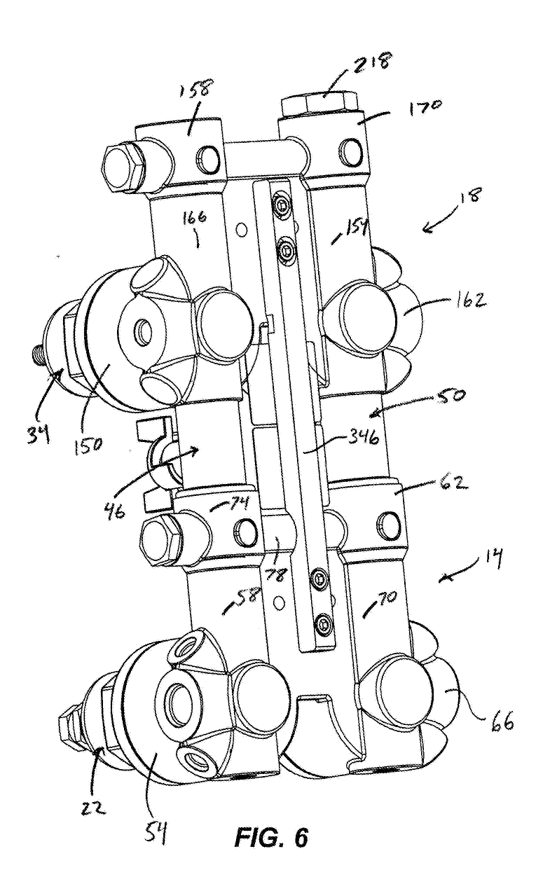

FIG. 6 shows a brace bar 346 (e.g., formed of stainless steel) installed on the medical gas manifold 10 and holding the bank body 14 to the line body 18. The brace bar 346 provides rigidity to the assembled manifold 10 and inhibits a service person from disassembling the manifold 10 without first disconnecting the pressurized gas supply. This may, for example, require a technician to completely remove the manifold 10 from a larger assembly in order for the manifold 10 to be disassembled or otherwise relevantly serviced. For example, if bolts are utilized to attach the brace bar 346 to the back side of the manifold 10, with the brace bar 346 acting to hold the two bodies 14, 18 of the manifold 10 together, in certain configurations the attachment bolts may only be accessed from the back side of the manifold 10. Such a configuration may ensure, for example, that before regulators included in the manifold 10 are disconnected or before the manifold 10 is otherwise serviced any relevant pressure supply is disconnected and the manifold is removed from any larger fluid-management (or other) assembly to which it is attached during normal manifold operation. The rigidity of the brace bar 346 inhibits flexing of the joints of the manifold 10. In certain embodiments, a stainless steel brace bar 346 may be utilized.

As discussed above, one or more regulator seats of one or more regulators 22, 26, 34, 38 may utilize a non-halogenated elastomer. In certain embodiments, one or more of the seats may be composed of a synthetic rubber-derived polymer. For example, the regulator seats may utilize a synthetic rubber-derived polymer such as hydrogenated nitrile butadiene rubber (“HNBR”). This may, for example, facilitate the use of the manifold 10 with a variety of fluid or gas types while avoiding the disadvantages discussed above.

The above described manifold can be used in a gas supply system such as that described in U.S. patent application Ser. No. 14/066,174 filed on Oct. 29, 2013 and naming the current inventors, the entire contents of which are incorporated herein by reference.

The inventive manifold 10 provides a number of advantages over prior systems. In other embodiments, the piston diaphragms may be replaced with more standard elastomer diaphragms, as desired. The manifold 10 provides a compact assembly that provides a more consistent installation, saved costs, and improves the quality of installations. All thread tape or paint and pipe threaded fittings are eliminated such that fully tightened and gasket or o-ring seals are utilized. This provides a more accurate installation and significantly reduces the incidence of leaks and installation errors. The reducing in leaks improves installation and maintenance efficiency.

In operation, the primary bank regulator 22 receives pressurized gas from the primary bank, the primary ball valve 46 is arranged in an open position, and the secondary ball valve 50 is arranged in a closed position. In this arrangement, the gas flows through the primary bank regulator 22 through the primary check valve 30, is inhibited from flowing to the secondary bank regulator by the secondary bank check valve 30. The gas then flows through the first line regulator 34 and is provided to the outlet at the line pressure. Alternatively, the secondary ball valve 50 may be left open such that flow is provided from the primary bank regulator 22 to both the first and second line regulators 34, 38.

To switch to the secondary bank, the ball valves 46 and 50 may be closed, and the secondary bank gas allowed to access the secondary bank regulator 26. Once the secondary bank is connected, the ball valves 46, 50 may be actuated to the desired position. Operation of the line regulators 34, 38 stays significantly the same. Many different arrangements and operational conditions are achievable with the manifold 10 and will be readily understood by those skilled in the art.

The relief pistons 220 discussed above help during changing states of the manifold 10 by allowing a user to relieve pressure within certain isolated regulators before servicing.

In some arrangements, the line check valves 42 may be eliminated, or replaced with another set of ball valves similar to the primary and secondary ball valves 46, 50.

In some embodiments, for example, in Canadian markets, the bank body 14 may be utilized without the line body 18 and instead using stand along regulators and valving downstream of the bank body 14.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

We claim:

1. A medical gas manifold comprising:
a bank body formed as a single body and including a primary bank regulator valve body and a secondary bank regulator valve body;
a primary bank regulator received within the primary bank regulator valve body;
a secondary bank regulator received in the secondary bank regulator valve body;
a line body formed as a single body and including a first line regulator valve body and a second line regulator valve body;
a first line regulator received in the first line regulator valve body;
a second line regulator received in the second line regulator valve body;
a primary ball valve fluidly coupling the first line regulator to the bank body; and
a secondary ball valve fluidly coupling the second line regulator to the bank body.

2. The medical gas manifold of claim 1, further comprising a check valve downstream of each of the primary bank regulator, the secondary bank regulator, the first line regulator, and the second line regulator.

3. The medical gas manifold of claim 1, wherein the primary bank regulator includes a regulator seat composed of hydrogenated nitrile butadiene rubber.

4. The medical gas manifold of claim 1, wherein the primary bank regulator includes a pistol style diaphragm.

5. The medical gas manifold of claim 1, wherein the primary bank regulator valve body receives a sintered brass filter element.

6. The medical gas manifold of claim 1, wherein at least one of the primary bank regulator valve body and the first line regulator valve body is configured to receive a relief piston.

7. The medical gas manifold of claim 1, wherein the primary bank regulator includes a piston assembly composed of one of a nickel-copper alloy and brass.

8. The medical gas manifold of claim 1, wherein the primary bank regulator includes a seat spring composed of Inconel.

9. The medical gas manifold of claim 1, wherein the primary bank regulator is balanced.

10. The medical gas manifold of claim 1, wherein the first line regulator is unbalanced.

11. The medical gas manifold of claim 1, wherein the primary bank regulator includes a pneumatic adjustment screw and is arranged such that the primary bank regulator may be any combination of spring loaded and dome loaded.

12. The medical gas manifold of claim 1, wherein all joints of the medical gas manifold are sealed via any one of gaskets and o-rings.

13. The medical gas manifold of claim 12, wherein the gaskets and o-ring are composed of hydrogenated nitrile butadiene rubber.

14. The medical gas manifold of claim 1, further comprising a bracing bar coupled to the bank body and the line body.

15. The medical gas manifold of claim 14, wherein the bracing bar is arranged to increase the rigidity of the medical gas manifold and inhibit the disassembly of the medical gas manifold unless the medical gas manifold is isolated from a pressure source.

16. A medical gas manifold comprising:
a bank body arranged to receive a primary bank regulator and a secondary bank regulator, the bank body forged as a single piece and subsequently machined to include a bank check valve portion, a bank coupling portion, and a bank branch;
a line body arranged to receive a first line regulator and a second line regulator, the line regulator forged as a single piece identical to the bank body and subsequently machined to include a line check valve portion, a line coupling portion, and a line branch; and
a ball valve fluidly connecting the bank coupling portion to the line body to provide a flow path from the bank body to the line body.

17. The medical gas manifold of claim 16, further comprising a bracing bar coupling the bank body to the line body.

18. The medical gas manifold of claim 16, wherein the medical gas manifold is sealed without the use of sealing tape or paint.

19. The medical gas manifold of claim 16, wherein the medical gas manifold is arranged such that the primary bank regulator, the secondary bank regulator, the first line regulator, and the second line regulator may be isolated and serviced without complete disassembly of the medical gas manifold.

20. The medical gas manifold of claim 16, further comprising a second ball valve connecting the bank coupling portion to the line body to provide a second flow path from the bank body to the line body.
